(19) United States
(12) Patent Application Publication
(10) Pub. No.: US 2005/0052076 A1
(43) Pub. Date: Mar. 10, 2005

(54) Vehicular brake control device

(76) Inventors: Takashi Watanabe, Kariya-city (JP); Shoichi Nasaki, Kariya-city (JP); Moriharu Sakai, Kariya-city (JP)

Correspondence Address: POSZ & BETHARDS, PLC, 11250 ROGER BACON DRIVE, SUITE 10, RESTON, VA, 20190, US

(21) Appl. No.: 10/934,431

(22) Filed: Sep. 7, 2004

(30) Foreign Application Priority Data
Sep. 10, 2003 (JP) 2003-318469

(51) Int. Cl. B60T 8/34

(52) U.S. Cl. 303/113.1

(57) ABSTRACT

An emergency determination mechanism determines whether the necessity of an emergency stop of a vehicle is high. If the emergency determination mechanism determines that the necessity of the emergency stop is high, a granular object sprinkling device sprinkles granular objects on a road surface in front of a vehicle in a running direction. At the same time, when the granular object sprinkling device is operated to sprinkle the granular objects, an ABS control device changes the setting of a target slip ratio as a target value in ABS control from a relatively small first value to a relatively large second value.

### CROSS REFERENCE TO RELATED APPLICATION

This application is based upon and claims the benefit of Japanese Patent Application No. 2003-318469 filed on Sep. 10, 2003, the content of which are incorporated herein by reference.

### FIELD OF THE INVENTION

The present invention relates to a vehicular brake control device for reducing the braking distance of a vehicle. The reduction in the braking distance is carried out using, in combination, a normal brake device for generating a friction force between tires and a road surface by suppressing rotational torque of wheels, and a granular object sprinkling device for sprinkling granular objects such as sand to the road surface.

### BACKGROUND OF THE INVENTION

In a related vehicular brake control device, slippage of tires of a running vehicle is detected, and, during slippage, granular objects such as granular ice pieces are sprinkled or generated at the contact area between the tires and the road surface for generating unevenness of the granular ice pieces on the road surface, thereby increasing the contact friction force between the tires and the road surface to stop the tire slippage (for example, see Japanese Patent Application Laid Open No. HEI 7-309101 and Japanese Paten Application Laid Open No. HEI 8-25905).

At the time of emergency braking, if an anti-lock brake control (hereinafter referred to as “ABS control”) is not employed, the tires are likely to be slipped easily, and locked at an early stage. In the slip condition or locked condition, if the granular objects are sprinkled on the surface in front of the tires in the running direction, the granular objects are sandwiched between the locked tires and the road surface, and the granular objects bite into the road surface. Thus, so called the spike effect (or Russell effect) is obtained to achieve a relatively large reduction in the braking distance.

When the ABS control is performed, locking of the tires does not occur. Therefore, even if the granular objects are sprinkled on the road surface, the locking-free tires rotate on the granular objects, and the granular objects are not likely to be sandwiched between the tires and the road surface. Thus, the spike effect can not be achieved satisfactorily, and the reduction in the braking distance is small.

In the related art, in either case, the granular object sprinkling device is operated by a signal indicating slippage of tires from the ABS control device or the like. Thus, the granular objects are sprinkled to the tires which are prevented from being locked. Therefore, in the related art, the spike effect of the granular objects between the tires and the road surface can not be achieved satisfactorily. The effect of the reduction in the braking distance may be small, i.e., the braking distance may be long.

### SUMMARY OF THE INVENTION

An object of the present invention is to provide a vehicular brake control device in which even if granular objects are sprinkled between tires and the road surface during the ABS control, the effect of the reduction in the braking distance is maintained.

According to a first aspect of the present invention, a target slip ratio is set to a first value when the granular object sprinkling device is not operated to sprinkle the granular objects, and the target slip ratio is set to a second value which is larger than the first value when the granular object sprinkling device is operated to sprinkle the granular objects.

According to the present invention, an emergency determination mechanism determines whether the necessity of an emergency stop of the vehicle is high. If the emergency determination mechanism determines that the necessity of the emergency stop is high, the granular object sprinkling device sprinkles granular objects on a road surface in front of the vehicle in a running direction. At the same time, if the granular object sprinkling device is operated to sprinkle the granular objects on the road surface, the ABS control device changes the setting of the target slip ratio as a target value in the ABS control from a relatively small first value to a relatively large second value.

Thus, when the granular objects are sprinkled on the road surface because the necessity of the emergency stop is high, the target slip ratio in the ABS control is changed significantly. Therefore, the rotational speeds of the wheels are likely to be lowered (the slip ratio is likely to be increased), and locking is likely to occur.

Thus, when the wheels having the large slip ratio, or the locked wheels ride on the granular objects sprinkled on the road surface, the granular objects are sandwiched between the wheels and the road surface. The friction coefficient between the wheels and the road surface is increased by the spike effect. Accordingly, the braking distance of the vehicle is further reduced.

For example, small stones (or gravel) made from a rock or fine particles of sand made from a rock, or granular ice pieces may be used as the granular objects. As the grain size gets larger, the spike effect gets larger or the friction coefficient gets larger. Therefore, the effect of reduction in the braking distance is large.

In this configuration, for example, the emergency determination mechanism may determine that the necessity of the emergency stop is high if a physical amount indicating braking intention of a driver of the vehicle is greater than a predetermined threshold, and a vehicle body deceleration of the vehicle is smaller than a predetermined threshold.

That is, if the physical amount indicating braking intention of the driver of the vehicle is large, i.e., if the driver has an intention to stop the vehicle urgently, but the actual vehicle body deceleration is small, namely, the vehicle is not going to stop, it is determined that it is necessary to stop the vehicle urgently.

For example, the physical amount of indicating braking intention of the driver may be a depression force applied to a brake pedal of the vehicle or a pressure force generated by a master cylinder which is pressurized by controlling the brake pedal. If the braking intention of the driver is large, naturally, the driver depresses the brake pedal strongly. Therefore, each of the depression force applied to the brake pedal and the pressure force generated by the master cylinder which is pressurized by depression of the brake pedal is considered as the physical amount corresponding to the level of the driver's braking intention.

According to a second aspect of the present invention, the granular object sprinkling device is operated to sprinkle the granular objects to the left and right front wheels of the vehicle only.

According to the present invention, the granular objects are sprinkled to the left and right front wheels only, and the target slip ratio is increased in correspondence with sprinkling of the granular objects. Thus, the friction coefficient between the left and right front wheels and the road surface is increased by the spike effect of the granular objects. Therefore, the strong braking force is generated by the left and right front wheels, and the effect of the reduction in the braking distance is achieved. By distributing the braking force to the front wheels and rear wheels, stability of the vehicle is achieved.

According to a third aspect of the present invention, the granular object sprinkling device is operated to sprinkle the granular objects at least the left and right front wheels of the vehicle, and the anti-locking brake control device sets the target slip ratio to the second value for the left and right front wheels of the vehicle only.

According to the present invention, the granular object sprinkling device is operated to sprinkle the granular objects to the left and right front wheels, and, at the same time, the target slip ratio in the ABS control is changed to the relatively large second value for the left and right front wheels only. Thus, a large braking force is generated at the left and right front wheels, and the effect of the reduction in the braking distance is achieved. Since the normal ABS control is performed using the relatively small first value for the left and right rear wheels, the slip ratio of the left and right rear wheels is not increased. Thus, stability of the vehicle is achieved.

According to a fourth aspect of the present invention, the vehicular brake control device includes a steering angle detection mechanism for detecting a steering angle. The anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

In general, when the front wheels controlled by the steering wheel are locked, it is no longer possible to perform steering operation. Conversely, if the slip ratio of the front wheels is small, or if the front wheels are not locked easily by the ABS control, it is possible to perform steering operation of the steering wheel.

According to the present invention, if at least one of two conditions that (i) the steering angle as the operation amount of the steering wheel is greater than a threshold, (ii) an angle speed of the steering angle is greater than a threshold, is satisfied, it is determined that there is a steering request by the driver. If there is a steering request by the driver, or if the wheels are steered by the driver, the target slip ratio in the ABS control is not set to the relatively large second value, but set to the relatively small first value. Stated otherwise, if there is no steering request, or if the wheels are not steered by the driver, the target slip ratio is set to the relatively large second value. Thus, if the wheels are not steered by the driver, the target slip ratio is high, and the effect of the reduction in the braking distance is achieved. If the wheels are steered by the driver, the target slip ratio is set to the small value to enable the steering operation.

### BRIEF DESCRIPTION OF THE DRAWINGS

Other objects, features and advantages of the present invention will be understood more fully from the following detailed description made with reference to the accompanying drawings. In the drawings:

FIG. 1 is a diagram schematically showing an overall structure of a vehicle to which a vehicular brake control device according to a first embodiment of the present invention;

FIG. 2A is a flow chart showing part of a control routine of the vehicular brake control device according to the first embodiment of the present invention;

FIG. 2B is a flow chart showing part of a control routine that is performed after the process shown in FIG. 2A;

FIG. 3 is a flow chart showing a sprinkling operation routine;

FIG. 4 is a timing chart showing a result of ABS control;

FIG. 5 is a view schematically showing an overall structure of a vehicle to which a vehicular brake control device according to a second embodiment of the present invention; and

FIG. 6 is a flow chart showing part of a control routine according to the second embodiment.

### DETAILED DESCRIPTION OF THE PREFERRED EMBODIMENTS

The present invention will be described further with reference to various embodiments in the drawings.

First Embodiment

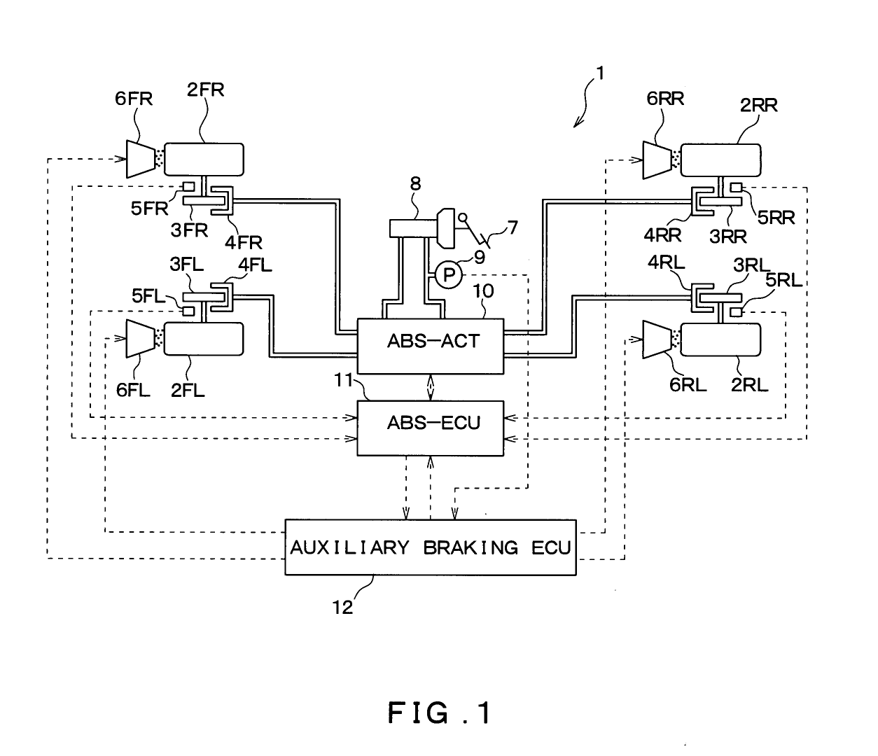

Hereinafter, a first embodiment of the present invention will be described with reference to drawings. FIG. 1 is a diagram schematically showing an overall structure of a vehicle 1 to which a vehicular brake control device according to the first embodiment of the present invention is applied.

The vehicle 1 includes a left front wheel 2FL, a right front wheel 2FR, a left rear wheel 2RL, and a right rear wheel 2RR. Disk rotors 3FL-3RR, wheel cylinders (hereinafter referred to as “W/C”) 4FL-4RR, wheel speed sensors 5FL-5RR, and granular objet sprinkling devices 6FL-6RR are provided at the respective wheels 2FL-2RR. The disk rotors 3FL-3RR rotate together with the wheels 2FL-2RR.

The W/Cs 4FL-4RR are pressurized by the fluid pressure generated by an ABS actuator (ABS-ACT) 10 (to be described later) to press friction members (not shown) on the disk rotors 3FL-3RR, respectively. Thus, the rotational forces of the disk rotors 3FL-3RR are suppressed by the pressure force, namely, a friction force corresponding to the pressing force. Therefore, braking forces are generated between tires of the respective wheels 2FL-2RR and the road surface. The wheel speed sensors 5FL-5RR detect rotational speeds of the disk rotors 3FL-3RR, and output the detection results as wheel speed signals to an ABS control ECU 11 (to be described later).

Each of the granular object sprinkling devices 6FL-6RR functions as an auxiliary braking mechanism, and includes a tank for storing granular objects such as sand or small stones (gravel), and a shutter provided at a lower portion of the tank to open and close the tank. The granular object sprinkling devices 6FL-6RR are provided at positions in front of the wheels 2FL-2RR in a running direction of the vehicle. When the shutters are opened by a drive signal from an auxiliary braking ECU 12 (to be described later), the granular object sprinkling devices 6FL-6RR drop the granular objects. Thus, the granular objects are sprinkled on the road surface in front of the wheels 2FL-2RR in the running direction, and the wheels 2FL-2RR ride on the granular objects.

At this time, if the slip ratio of the wheels 2FL-2RR is large, i.e., if the rotational speeds of the wheels 2FL-2RR are low, granular objects are sandwiched between the wheels 2FL-2RR and the road surface to produce a spike effect (or Russell effect) where granular objects are stacked like wedges. Since the granular objects stacked like wedges are sandwiched between the wheels 2FL-2RR and the road surface, its spike effect increases the friction coefficient between the road surface and the wheels 2FL-2RR which have low rotational speeds or which have been locked. Thus, the braking force is increased. The spike effect gets larger as the slip ratio of the wheels 2FL-2RR increases. Conversely, if the slip ratio is small, the wheels 2FL-2RR smoothly move on the granular objects by rotation, and thus, the spike effect is small.

The vehicle 1 further includes a brake pedal 7, a master cylinder (hereinafter referred to as “M/C”) 8, a pressure sensor 9, an ABS actuator (ABS-ACT) 10, an ABS control ECU (ABS-ECU) 11, and an auxiliary braking ECU 12.

If the brake pedal 7 is operated in accordance with the driver's braking request, the M/C 8 generates an M/C pressure as the fluid pressure in accordance with the pedal operation amount. The M/C pressure is transmitted to the ABS actuator 10. The pressure sensor 9 detects the M/C pressure, and outputs the detected M/C pressure as an M/C pressure signal to the auxiliary braking ECU 12 (to be described later).

The ABS actuator 10 is configured to control (increase, maintain, or decrease) the W/C pressure generated at the respective W/Cs 4FL-4RR independently in correspondence with a control signal from the ABC control ECU 11. The ABS actuator 10 has a conventional, well known structure, and thus, description about the detailed structure of the ABS actuator 10 will be omitted.

The ABS control ECU 11 comprises a microcomputer. At the time of braking, the ABS control ECU 11 determines that wheels are likely to be locked based on the slip ratio calculated in correspondence with the detection signals from the wheel speed sensors 5FL-5RR and the vehicle body deceleration, and drives the ABS actuator 10 by a control signal to decrease, maintain, or increase the W/C pressure applied to the wheels which are likely to be locked. By this ABS control, the slip ratio is guided toward a predetermined target slip ratio (first value KSN) for avoiding the locking tendency.

Further, the ABS control ECU 11 changes the setting of the target slip ratio for the left and right front wheels 2FL, 2FR from a normal relatively small first value KSN to a relatively large value KSL depending on whether the granular object sprinkling devices 6FL-6RR are operated, i.e., whether the granular objects are sprinkled on the road surface.

That is, the ABS actuator 10 and the ABS control ECU 11 function as anti-lock brake control devices for controlling the braking force applied to the respective wheels 2FL-2RR of the vehicle 1 based on the target slip ratio to reduce the occurrence of locking at the respective wheels 2FL-2RR.

The auxiliary braking ECU 12 comprises a microcomputer. The auxiliary braking ECU 12 determines whether an emergency stop is necessary based on the vehicle body deceleration dVB used in the ABS control calculated by the ABS control ECU 11, and the M/C pressure signal detected by the pressure sensor 9. If it is determined that the emergency stop is necessary, the auxiliary braking ECU 12 outputs a drive signal to open the shutters of the granular object sprinkling devices 6FL, 6FR to sprinkle the granular objects for at least the left and right front wheels 2FL, 2FR. Thus, the auxiliary braking ECU 12 corresponds to an emergency determination mechanism in the present invention.

At this time, additionally, the shutters of the granular object sprinkling devices 6RL, 6RR for the left and right rear wheels 2RL, 2RR may be opened for sprinkling the granular objects for all of the four wheels, thereby further enhancing the effect of the reduction in the braking distance of the vehicle. In the first embodiment, it is assumed that sprinkling of the granular objects is performed for only the left and right front wheels 2FL, 2FR.

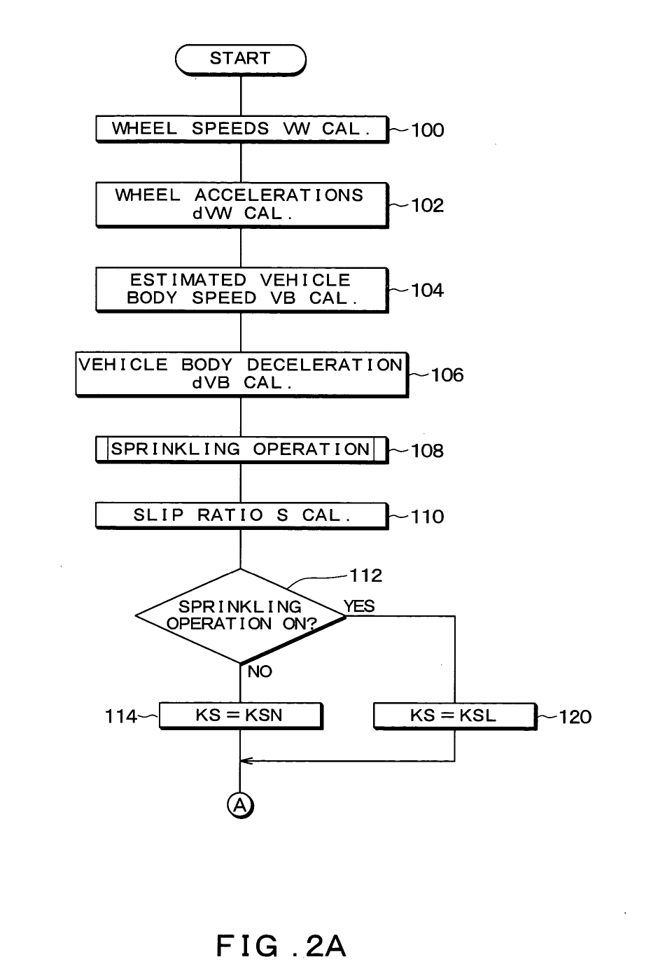

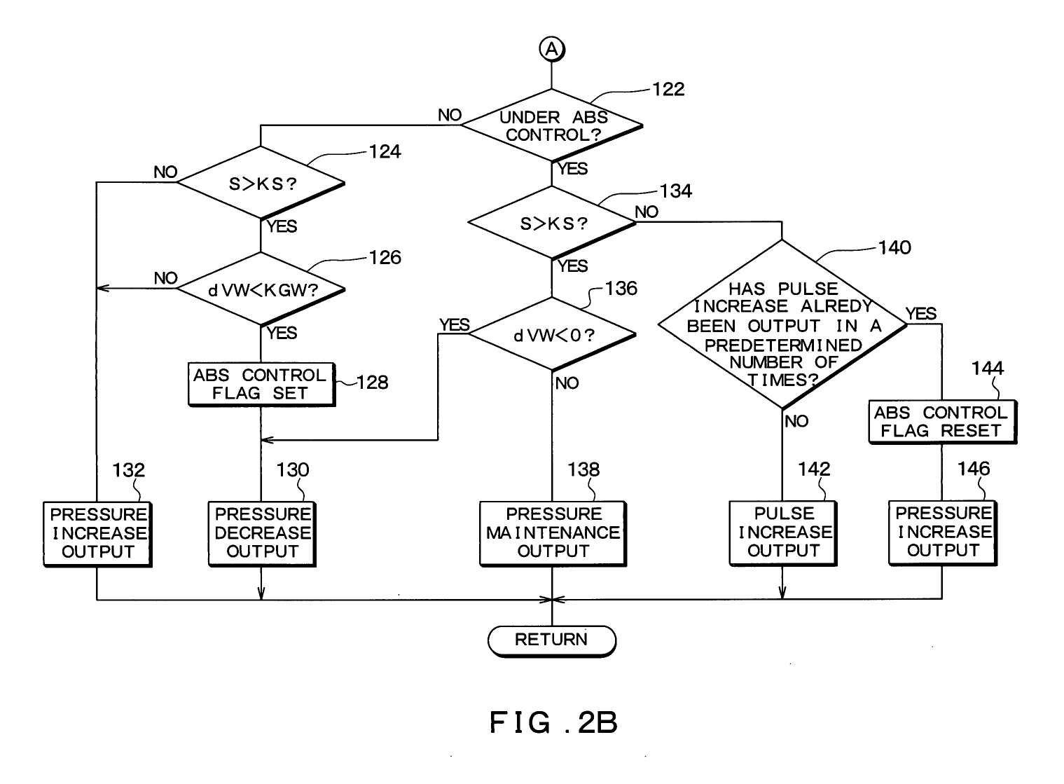

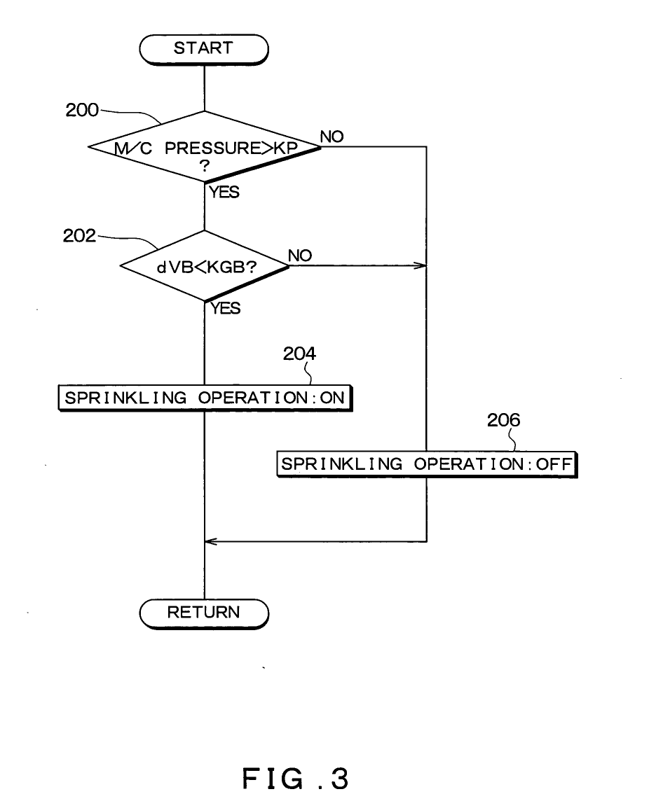

Next, operation of the vehicle brake control device according to the first embodiment of the present invention will be described with reference to flow charts shown in FIGS. 2A, 2B, and FIG. 3. The flow charts in FIGS. 2A, 2B and FIG. 3 show a processing sequence of a control routine carried out in a cooperative manner by the ABS control ECU 11 and the auxiliary braking ECU 12. In the control routine, the control process is started when an ignition switch is turned on. The control routine is repeatedly carried out in a predetermined calculation cycle.

In FIG. 2A, at 100, wheel speeds VWFL-VWRR of the respective wheels are calculated based on signals from the respective wheel speed sensors 5FL-5RR. Next, at 102, the wheel speeds VWFL-VWRR are differentiated to calculate wheel accelerations dVWFL-dVWRR of the respective wheels. Next, at 104, an estimated vehicle body speed VB is calculated. Specifically, the wheel speed with the maximum value in the wheel speeds VWFL-VWRR is selected as the estimated vehicle body speed VB. Further, at 106, the estimated vehicle body speed VB is differentiated to calculate a vehicle body deceleration dVB. The above processes are carried out by the ABS control ECU 11.

Next, at 108, a sprinkling operation routine shown in the flow chart in FIG. 3 is carried out by the auxiliary braking ECU 12. The sprinkling operation routine is carried out for both of the left and right front wheels 2FL, 2FR simultaneously. In FIG. 3, at 200, it is determined whether the M/C pressure as a value detected by the pressure sensor 9 is greater than a predetermined threshold KP. If the determination result is YES, i.e., if the M/C pressure is greater than the threshold KP, the brake pedal 7 is depressed by the driver strongly, and the necessity of the emergency stop is high. Thus, the routine proceeds to the processing at 202. If the determination result is NO, i.e., if the M/C pressure is not greater than the threshold KP, the brake pedal 7 is not depressed strongly by the driver, and the necessity of the emergency stop is low. Thus, the routine proceeds to the processing at 206.

At 202, it is determined whether the vehicle body deceleration dVB is smaller than a predetermined threshold KGB (e.g., 0.2G, where G is the gravity acceleration). If the determination result is YES, i.e., if the vehicle body deceleration dVB is smaller than the threshold KGB, the vehicle body deceleration dVB is not increased, i.e., the vehicle is not in a deceleration state, even though the brake pedal 7 is depressed strongly by the driver, and the emergency stop is necessary. Thus, the routine proceeds to the processing at 204. If the determination result is NO, i.e., if the vehicle body deceleration dVB is not smaller than the threshold KGB, the vehicle speed VB is decelerated at the large deceleration dVB in accordance with the strong depression of the brake pedal 7 by the driver. Thus, the emergency stop is not necessary, and the routine proceeds to the processing at 206.

At 204, the granular object sprinkling devices 6FL, 6FR provided at the left and right front wheels 2FL, 2FR are driven for performing the emergency stop of the vehicle. Thus, the shutters for the granular object sprinkling devices 6FL, 6FR are opened, and the granular objects stored in the tank are sprinkled on the road surface in front of the left and right front wheels 2FL, 2FR.

At 206, operations of the granular object sprinkling devices 6FL, 6FR are stopped. Thus, the shutters of the granular object sprinkling devices 6FL, 6FR are closed, and the granular objects are not sprinkled on the road surface any more. At 204 and 206, flags indicating that the granular object sprinkling devices 6FL, 6FR are operated are set.

By the above processing, the necessity of the emergency stop of the vehicle is determined. If the emergency stop is necessary, the granular object sprinkling devices 6FL, 6FR for the left and right front wheels 2FL, 2FR are operated, and the granular objects are sprinkled between the left and right wheels 2FL, 2FR and the road surface. If the emergency stop is not necessary, the operations of the granular object sprinkling devices 6FL, 6FR are stopped, and the granular objects are not sprinkled on the road surface.

After the sprinkling operation routine at 108 is finished, subsequently, the routine from the processing at 110 to the processing at 120 in FIG. 2A is performed. Though the routine from the processing at 110 to the processing at 120 is performed for each of the wheels 2FL-2RR by the ABS control ECU 11, FIG. 2A only shows the process flow for only one wheel.

At 110, the slip ratio S for each wheel is calculated by the equation Si=100×(VB−Vwi)/VB. In the equation, i indicates FL-RR (i=FL-RR). At 112, it is determined whether the sprinkling operation is ON based on the flags indicating whether the granular object sprinkling devices 6FL-6RR are operated or not. If the determination result is NO, i.e., if the granular object sprinkling device corresponding to the target wheel is not operated (non-sprinkling condition), at 114, the target slip ratio KS in the ABS control is set to a predetermined first value KSN (e.g., 20%). The first value KSN is a relatively small value used as the target slip ratio in the normal ABS control. In the first embodiment, sprinkling of the granular objects is not performed for the left and right rear wheels 2RL, 2RR. Therefore, the left and right rear wheels 2RL, 2RR are always in non-sprinkling condition, and thus, the first value KSN is the target slip ratio KS for the left and right rear wheels 2RL, 2RR.

At 112, if the determination result is YES, i.e., if it is determined that the granular object sprinkling device corresponding to the target wheel is operated (sprinkling condition), at 120, the target slip ratio KS in the ABS control is set to the predetermined second value KSL (e.g., 50%, this is, a slip ratio that is estimated when braking distance reduction effect by the spike effect is obtained).

As described above, the ABS control ECU 11 selectively sets the target slip ratio KS used in the ABS control to the relatively large second value KSL or the relatively small first value KSN depending on whether the granular object sprinkling devices 6FL, 6FR are operated or not. If the target slip ratio KS is set to the second value KSL, the slip ratio S of the left and right front wheels 2FL, 2FR under the ABS control is large. Therefore, the wheel speeds of the left and right wheels 2FL, 2FR fall significantly. Accordingly, the granular objects sprinkled by the granular object sprinkling devices 6FL, 6FR are sandwiched between the left and right front wheels 2FL, 2FR. The friction coefficient between the left and right front wheels 2FL, 2FR and the road surface is increased by the spike effect. Thus, by the increased braking forces of the left and right front wheels 2FL, 2FR, the effect of the reduction in the braking distance of the vehicle is achieved.

Further, the target slip ratio KS of the left and right rear wheels 2RL, 2RR remains set to the relatively small first value KSN. Therefore, the left and right rear wheels 2RL, 2RR are not locked, and the wheel speeds do not fall significantly. When the slip ratio S of the left and right front wheels 2FL, 2FR is large, even if the granular objects are sprinkled to the left and right front wheels 2FL, 2FR for emergency stop, the left and rear wheels 2RL, 2RR are not locked. Therefore, it is possible to prevent the vehicle 1 from spinning, and the running stability of the vehicle 1 can be achieved.

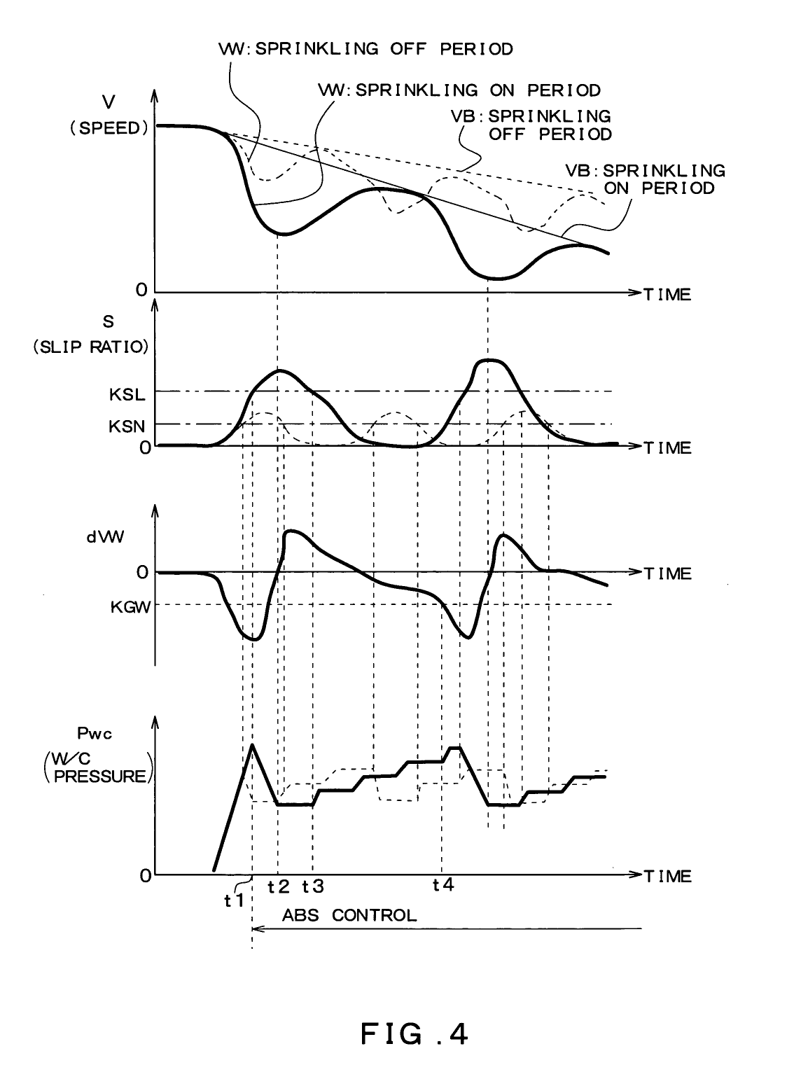

Next, in FIG. 2B, the ABS control routine from the processing at 122 to the processing at 146 is performed. The ABS control routine is performed by the ABS control ECU 11 for each of the wheels 2FL-2RR. FIG. 2B shows the process flow for only one wheel. A timing chart regarding the left front wheel 2FL under the ABS control is shown in FIG. 4. In graphs of FIG. 4, solid lines denote respective parameters when the sprinkling operation is carried out (operation is ON), and broken lines denote respective parameters when the sprinkling operation is not carried out (operation is OFF) for comparative purpose.

As shown in FIG. 4, the vehicle body deceleration dVB is relatively large when the sprinkling operation is performed in comparison with the vehicle body deceleration dVB when the sprinkling operation is not performed. Therefore, when the sprinkling operation is carried out, the braking distance is reduced.

The ABS control routine is similar to the routine of the normal ABS control. Therefore, the ABS control routine will be described briefly.

At 122, it is determined whether the target wheel is currently under the ABS control. If the target wheel is not under the ABS control, the routine proceeds to the processing at 124. If the target wheel is under the ABS control, the routine proceeds to the processing at 134.

When the ABS control is not performed, (i) if the current slip ratio S is not greater than the target slip ratio KS (=KSN or KSL) set at 114 or 120 (at 124), or (ii) if the wheel acceleration (deceleration) dVW is not smaller than the predetermined threshold KWG (e.g., −1.5G), i.e., dVW=KGW (at 126), the ABS control is not necessary. Therefore, a control signal is output to the ABS actuator 10 to further increase the W/C pressure in accordance with the brake operatoin amount (at 132). Thus, in the first embodiment, even if the granular objects are sprinkled at 108, the ABS control may not be started depending on the levels of the slip ratio S and the vehicle acceleration dVW. Stated otherwise, even if the ABS control is not performed, the granular objects may be sprinkled. That is, in the first embodiment, sprinkling of the granular objects is carried out regardless of whether the ABS control is currently performed.

At 124 and 126, if the slip ratio S is greater than the target slip ratio KS (KSN or KSL), and dVW<KGW, i.e., the vehicle deceleration dVW is greater than the threshold (e.g., −1.5G), the wheel is just before locked. Therefore, the ABS control is started, and the ABS control flag is set (at 128). Then, a control signal is output to the ABS actuator 10 for decreasing the current W/C pressure of the wheel (at 130, time t1).

When the ABS control is currently performed, (i) if the current slip ratio S is greater than the previously set target slip ratio KS (=KSN or KSL) (at 134), and (ii) if the vehicle deceleration dVW is generated (dVW<0 at 136), the wheel is likely to be locked. Therefore, the current W/C pressure of the wheel is decreased (at 130, time t1 to t2). If the present slip ratio S is greater than the previously set target slip ratio KS (=KSN or KSL), and the vehicle deceleration dVW is not generated (dVW=0, at 136), the vehicle is recovering from the locked condition. Therefore, a control signal is output to the ABS actuator 10 for maintaining the current W/C pressure of the wheel (at 138, time t2 to t3).

When the ABS control is currently performed, if the current slip ratio S is not greater than the target slip ratio KS (=KSN or KSL) (at 134), it is not likely that the wheel lock occurs, and it is possible to increase the braking force. Therefore, a control signal is output to the ABS actuator 10 for pulse increase to gradually increase the W/C pressure (at 140, 142). By the pulse increase, in one cycle, the W/C pressure is increased for a predetermined time period, and thereafter, the W/C pressure is maintained for a predetermined time period. The cycle is repeated within a predetermined number of times, e.g., five times (at 140). After the pulse increase is repeated the predetermined number of times (at 140), the ABS control is finished temporally (at 144, time t4). Then, a control signal is output to the ABS actuator 10 for increasing the W/C pressure in accordance with the depression of the brake pedal 7 (at 146).

Second Embodiment

Next, a second embodiment of the present invention will be described. The second embodiment is different from the first embodiment in that the driver's steering operation is considered at the time of changing the setting of the target slip ratio to the second value KSL. Therefore, only the feature of the second embodiment which is different from the first embodiment will be described.

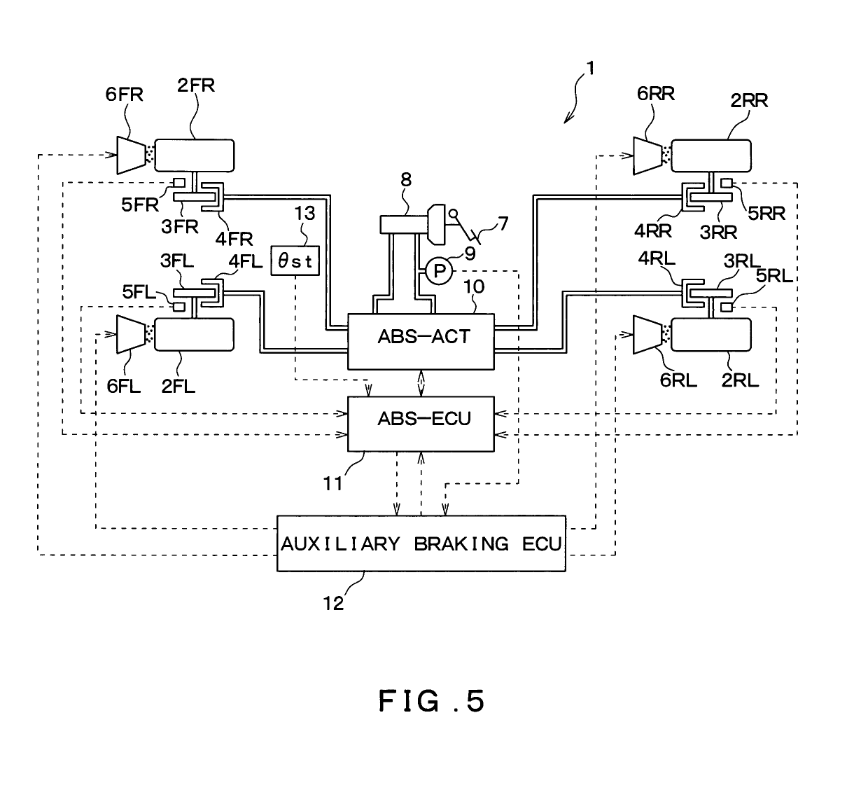

FIG. 5 is a diagram schematically showing an overall structure of a vehicle 1 to which a vehicular brake control device according to the second embodiment of the present invention is applied. The vehicular brake control device according to the second embodiment is different from the vehicular brake control device according to the first embodiment in that a steering angle sensor 13 as a steering angle detection mechanism is provided. Other structural features of the second embodiment are the same as those of the first embodiment. The steering angle sensor 13 detects the steering angle of the steering wheel, and outputs the detected steering angle as a steering angle signal θst to the ABS control ECU 11. The ABS control ECU 11 differentiates the steering angle signal θst from the steering angle sensor 13 for calculating the steering angle speed dθst.

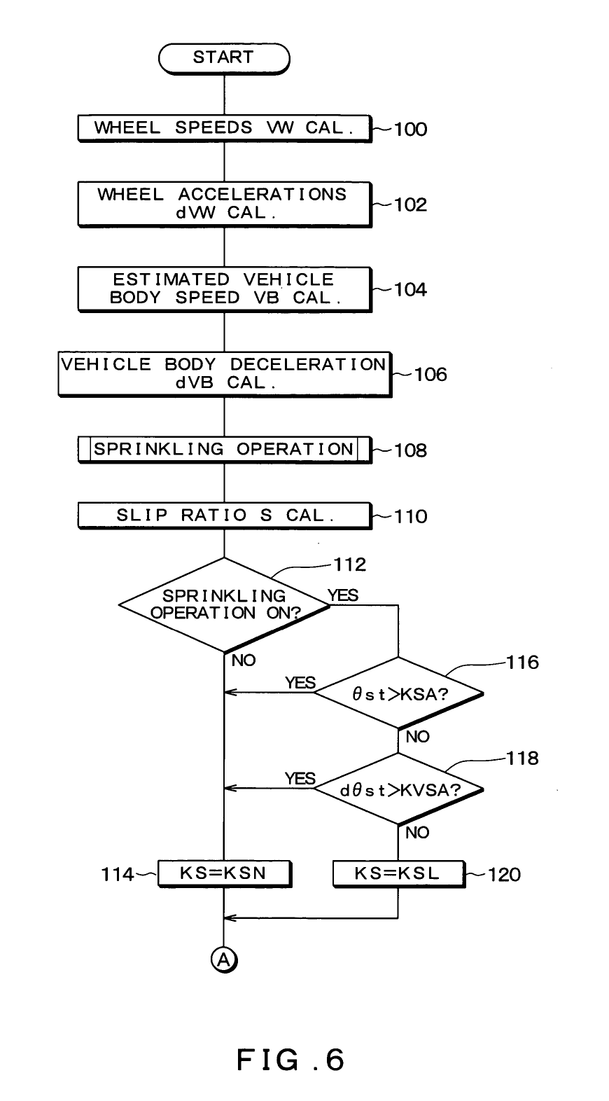

Next, operation of the vehicular brake control device according to the second embodiment will be described. The operation of the second embodiment is different from the operation of the first embodiment in that, in the control routines shown in the flow charts of FIGS. 2A, 2B and 3, the routine shown in FIG. 2A is not used, instead, the routine shown in FIG. 6 is used. Other routines are the same as those of the first embodiment. Hereinafter, only the routine shown in FIG. 6 will be described. In FIG. 6, the processes that are identical to those of the first embodiment shown in FIG. 2A are labeled with the same reference numerals, and descriptions thereof will be omitted.

At 112, if the determination result is YES, i.e., if it is determined that sprinkling is in operation, at 116, it is determined whether the steering angle θst is greater than a predetermined threshold KSA (e.g., 90 deg). If the determination result is YES, i.e., if the steering angle θst is greater than the threshold KSA, there is a steering request. Thus, the routine proceeds to the processing at 114 to perform the normal ABS control for enabling the steering operation.

If the determination result is NO at 116, i.e., if the steering angle θst is not greater than the threshold KSA, the routine proceeds to the processing at 118 for further determining whether there is a steering request. At 118, it is determined whether the steering angle speed dθst is greater than a predetermined threshold KVSA (e.g., 360 deg/sec). If the determination result is YES, i.e., if the steering angle speed dθst is greater than the threshold KVSA, there is a steering request. Thus, the routine proceeds to the processing at 114 to perform the normal ABS control for enabling the steering operation.

At 118, if the determination result is NO, i.e., if the steering angle speed θst speed is not greater than the threshold KVSA, the steering angle θst is small, and the steering angle speed dθst is small. Therefore, there is no steering request. Thus, at 120, the target slip ratio KS is set to the relatively large second value KSL.

By the above processing, in the second embodiment, if it is determined that the emergency stop is necessary, as with the first embodiment, the granular object sprinkling devices 6FL, 6FR for the left and right front wheels 2FL, 2FR are operated to sprinkle the granular objects on the road surface. At this time, in consideration of the steering operation, if the steering angle θst of the steering wheel is greater than the threshold KSA, or if the steering angle dθst is greater than the threshold KVSA, the setting of the target slip ratio KS for the left and right front wheels 2FL, 2FR under the ABS control is maintained at the relatively small first value KSN. Thus, the slip ratio of the left and right front wheels 2FL, 2FR controlled by the steering wheel is not increased by the ABS control, and the rotations of the left and right front wheels 2FL, 2FR are maintained. Accordingly, the steering angle in accordance with the steering operation is generated at the left and right front wheels 2FL, 2FR. In this manner, the reliable steering operation of the vehicle is performed.

Other Embodiments

In the first and second embodiments, sprinkling of the granular objects is performed by driving the granular object sprinkling devices 6FL, 6FR for the left and right front wheels 2FL, 2FR, respectively, and sprinkling of the granular objects is not performed for the left and right rear wheels 2RL, 2RR. Alternatively, the granular object sprinkling devices 6RL, 6RR for the left and right rear wheels 2RL, 2RR may also be driven in the same manner as the granular object sprinkling devices 6FL, 6FR for the left and right front wheels 2FL, 2FR. In this case, the sprinkling operation routine shown in FIG. 3, and the routine from the processing at 110 to the processing at 120 in FIG. 2A are performed for the left and right rear wheels 2RL, 2RR by the auxiliary control ECU 12. Thus, the setting of the target slip ratio KS in the ABS control is changed to the second value KSL. Therefore, all of the four wheels 2FL-2RR can receive the spike effect which is achieved by sprinkling the granular objects between the wheels having the low rotational speeds and the road surface. Accordingly, the effect of reducing the braking distance is further enhanced.

In the first and second embodiments, 50% is given as the second KSL value, for example. It should be noted that various values can be used as the second value KSL depending on the relationship between the size of the granular objects and the friction coefficient of the road surface as long as the second value KSL is greater than the first value KSN (e.g., 20%) used in the normal ABS control. For example, when the particle size of the granular objects is small such as the particles of sand, if the second value KSL is much larger, (e.g., 100%), the spike effect can be achieved more reliably.

While the above description is of the preferred embodiments of the present invention, it should be appreciated that the invention may be modified, altered, or varied without deviating from the scope and fair meaning of the following claims.

1. A vehicular brake control device including an anti-locking brake control device for reducing the occurrence of locking at respective wheels of a vehicle by controlling a braking force applied to the respective wheels based on a target slip ratio, the vehicular brake control device comprising:
an emergency determination mechanism for determining whether the necessity of an emergency stop of the vehicle is high; and
a granular object sprinkling device operated to sprinkle granular objects on a road surface in front of the vehicle in a running direction if it is determined that the necessity of the emergency stop is high,
wherein the anti-locking brake control device sets the target slip ratio to a first value when the granular object sprinkling device is not operated to sprinkle the granular objects, and sets the target slip ratio to a second value which is larger than the first value when the granular object sprinkling device is operated to sprinkle the granular objects.

2. The vehicular brake control device according to claim 1, wherein the emergency determination mechanism determines that the necessity of the emergency stop is high if a physical amount indicating braking intention of a driver of the vehicle is greater than a predetermined threshold, and vehicle body deceleration of the vehicle is smaller than a predetermined threshold.

3. The vehicular brake control device according to claim 2, wherein the physical amount indicating braking intention of the driver is a depression force applied to a brake pedal of the vehicle or a pressure force generated by a master cylinder which is pressurized by operating brake pedal.

4. The vehicular brake control device according to claim 1, wherein the granular object sprinkling device is operated to sprinkle the granular objects to left and right front wheels of the vehicle only.

5. The vehicular brake control device according to claim 2, wherein the granular object sprinkling device is operated to sprinkle the granular objects to left and right front wheels of the vehicle only.

6. The vehicular brake control device according to claim 3, wherein the granular object sprinkling device is operated to sprinkle the granular objects to left and right front wheels of the vehicle only.

7. The vehicular brake control device according to claim 1, wherein the granular object sprinkling device is operated to sprinkle the granular objects to at least left and right front wheels of the vehicle, and the anti-lock brake control device sets the target slip ratio to the second value for the left and right front wheels of the vehicle only.

8. The vehicular brake control device according to claim 2, wherein the granular object sprinkling device is operated to sprinkle the granular objects to at least left and right front wheels of the vehicle, and the anti-lock brake control device sets the target slip ratio to the second value for the left and right front wheels of the vehicle only.

9. The vehicular brake control device according to claim 3, wherein the granular object sprinkling device is operated to sprinkle the granular objects to at least left and right front wheels of the vehicle, and the anti-lock brake control device sets the target slip ratio to the second value for the left and right front wheels of the vehicle only.

10. The vehicular brake control device according to claim 1, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

11. The vehicular brake control device according to claim 2, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

12. The vehicular brake control device according to claim 3, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

13. The vehicular brake control device according to claim 4, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

14. The vehicular brake control device according to claim 5, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

15. The vehicular brake control device according to claim 6, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

16. The vehicular brake control device according to claim 7, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

17. The vehicular brake control device according to claim 8, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.

18. The vehicular brake control device according to claim 9, further comprising a steering angle detection mechanism for detecting a steering angle, wherein the anti-lock brake control device sets the target slip ratio to the first value if at least one of two conditions that (i) the steering angle is greater than a threshold, (ii) a steering angle speed is greater than a threshold, is satisfied when the granular object sprinkling device is in operation.
